(19) United States
(12) Patent Application Publication
(10) Pub. No.: US 2021/0108428 A1
(43) Pub. Date: Apr. 15, 2021

(54) SYSTEM COMPRISING AT LEAST ONE FIRST DEVICE MOVABLE IN A CONTROLLED MANNER AND AT LEAST ONE SECOND DEVICE, WHICH IS ARRANGED ON SAID AT LEAST ONE FIRST DEVICE, FOR APPLYING MATERIAL

(71) Applicant: Braun Project Engineering Gmbh, Altheim (DE)

(72) Inventor: Anja-Tatjana Braun, Altheim (DE)

(21) Appl. No.: 16/606,608

(22) PCT Filed: Apr. 20, 2018
(86) PCT No.: PCT/EP2018/060179

§ 371 Date: Oct. 18, 2019

(30) Foreign Application Priority Data
Apr. 21, 2017 (DE) 10 2017 108 509.2

(51) Int. Cl. E04G 21/04; B64C 39/02; B64D 1/18; E04B 1/16; E04B 1/35; B33Y 30/00; B33Y 40/00; B33Y 50/02

(52) U.S. Cl. CPC E04G 21/0436; B64C 39/024; B64D 1/18; E04B 1/16; E04B 1/3505; B33Y 30/00; B33Y 80/00; B33Y 50/02; B64C 2201/027; B64C 2201/108; B64C 2201/12; B64C 2201/101; B64C 2201/128; B33Y 40/00

(57) ABSTRACT

The invention relates to a system (10) comprising at least one first device (20) movable in a controlled manner and at least one second device (27), which is arranged on said at least one first device, for applying material. In order to produce complex structures in a simple manner, according to the invention, the at least one first device (20) movable in a controlled manner is formed by an aircraft (20) provided with at least one rotor (21), which aircraft comprises at least one container (231; 232) for storing the material.

The invention relates to a system comprising at least one first device movable in a controlled manner and at least one second device, which is arranged on said at least one first device, for applying material, in accordance with the preamble of claim 1.

A conventional system is known from WO 2004/065 707 A2. In this known system for erecting building walls, the first device movable in a controlled manner is movable on a suspension which is displaceable three-dimensionally in the manner of a robot arm.

The object of the invention is to configure a system in such a way that the material can be applied in a simple manner even for complex wall structures and relatively large heights.

This object is achieved by a system having the features of claim 1. Advantageous embodiments of the invention are set out in the dependent claims relating thereto.

The system according to the invention comprises at least one aircraft provided with at least one rotor, as a first device, and at least one second device arranged thereon for applying material. It is distinguished from the prior art in that the device movable in a controlled manner is formed by an aircraft that can perform any desired displacements, which go far beyond the freedom of displacement of a robot arm. Meanwhile, the aircraft used in the system according to the invention has at least one container for storing the material. As a result of a storage container of this type, the aircraft is independent from the supply of further material, at least at times. In other words, the invention could also be referred to in short as a “drone with material storage container and 3D print head.” The system according to the invention thus makes it possible, for example, to erect a building work in a highly automated manner, without it being necessary to use robots, scaffolds, cranes, conveyor belts or inclined elevators for this purpose.

The device for applying material preferably comprises at least a nozzle or a print head, by means of which preferably liquid or paste materials can be deposited at a desired position, which can be controlled by the aircraft.

The at least one container is connected to the device by means of at least one pump. This is preferably controllable in its performance in terms of amount conveyed per unit time. An advantageous development provides that the conveying pressure of the pump can also be adjusted for adaptation to materials of differing flowability.

Particularly preferably, in a system according to the invention the aircraft has at least two storage containers, in which it is also possible to store different material components, which can preferably also be mixed in the second device for applying the material if required. These two components may for example be formed by a concrete and a quick-setting material for concrete. However, it is equally possible for an outer layer, for example consisting of a highly insulating, weather-resistant plastics material, to be applied as a first component and for an inner layer of concrete to be applied as a second component.

In an advantageous development of the system according to the invention, it is provided that the second device for applying or the at least one container arranged thereon is connected to at least one storage container via at least one material supply line.

It is further advantageous if the at least one material supply line is held at a level above the altitude of the aircraft by means of at least one support device. This facilitates the supply of the material to the aircraft.

A further advantageous embodiment of the invention provides that the storage container is arranged at a level above the altitude of the aircraft. In this case, the storage container may be arranged either on an adjacent building, on a crane or lifting platform, or else alternatively be arranged floating by means of at least one lifting body. This additionally facilitates the supply of the material to the aircraft.

A particularly advantageous development of the invention provides that the aircraft is provided with at least one lifting container. A lifting container of this type, which may be filled with a gas lighter than air, reduces the required motor power for driving the motors of the aircraft and thus the energy requirement of said aircraft for maintaining a floating state.

The system according to the invention is further distinguished in that the aircraft is provided with a receiver that is in a preferably wireless data transmission connection with a control apparatus, such as a radio connection or a Bluetooth connection. As a result, an operator located on the ground can intervene in the control of the aircraft in a simple manner.

A program memory, which is provided in the aircraft itself or in a ground-level control apparatus, which is in a preferably wireless data transmission connection with the aircraft, serves to store at least one operating program comprising position data for the aircraft and comprising material metering data for the device and/or the pump.

In general, a program (the “building plan”), for erecting the walls, including the openings provided in the walls, of a building work by layer-wise material application, may also be arranged in a program memory of the aircraft itself rather than in a ground-level control apparatus. In this context, at least partial self-control or self-organization is possible, for example in the form of AI algorithms or in the form of swarm intelligence. The latter applies in particular if a plurality of aircraft are used simultaneously in a system according to the invention, one of which can take on a “master function” for simultaneously controlling its own flight displacements and for collision-free control of the flight displacements of all other aircraft for optimal execution of the building plan program.

A particularly preferred embodiment of the invention provides that the aircraft is formed by a drone. A drone is displaceable in various ways by means of a plurality of rotors, and can therefore produce even complex shapes and contours using the applied material.

A preferred application of a system according to the invention involves the aircraft being used for erecting a wall of a building. In this context, the device for applying material is particularly preferably useable for applying concrete.

It is further advantageous for a system according to the invention if the aircraft is provided with at least one device for applying attachment parts. These attachment parts may for example be formed by formwork devices, by window or door frames or by reinforcing parts, such as fiber mats or steel mats that are to be worked into a building ceiling. Using a system according to the invention, mats of this type can even be woven in the manner of a spider web from a “thread” extruded for example from a second device, by corresponding crossing displacement paths of one or more aircraft.

The system according to the invention may comprise a plurality of aircraft, which are displaceable synchronously or asynchronously by means of a shared control device to implement a shared building plan. In this context, the devices for material application or application devices of the plurality of aircraft may be formed for application of similar or else of different materials. In this context, at least partial self-control or self-organization is possible, for example in the form of AI algorithms or in the form of swarm intelligence. The control device or control apparatuses that form part of the system are preferably equipped with a software application, by means of which, for implementing building works, CAD data of a building plan can be converted into position coordinates of one or more aircraft, and particularly preferably, for developing building plans, position coordinates can also conversely be converted into CAD data. Further, the position coordinates can also be displayed in the control appliance for monitoring the actual values (for construction monitoring or quality control). As an alternative or in addition to GPS navigation of the aircraft, position control thereof by means of laser mapping is also provided. In this context, the cooperation with GPS data can also take place by way of multimode navigation. In this case, the CAD data of the building work to be erected are converted into geometric contours. The aircraft may optionally be displaced to the predetermined positions to a precision of 1 mm accuracy with the assistance of additional laser reflectors. In this context, in particular for extended, larger building works, it is also possible for rough positioning to take place by GPS and fine positioning by laser mapping.

To increase the precision, the nozzle or print head for applying material may be mounted on a beam kinematic system, such as is supplied by FESTO under the name “Stabkinematik EXPT, Tripod.” In this way, deviations of the aircraft due to wind and weather can be compensated very sensitively and with a high reaction speed.

A further advantageous embodiment of the invention provides that the second device for applying material is provided with a trunk-like and/or telescopically extendable and retractable handling assistant, by means of which the nozzle or print head for applying material can even be guided exactly into gaps between reinforcements or armoring. A suitable handling assistant is for example the bionic handling assistant developed by FESTO in cooperation with the Fraunhofer Institute for Manufacturing Engineering and Automation, which was awarded the 2010 German Future Prize.

A useful additional function of the system according to the invention is that it can also take on additional logistical functions on a building site. Thus, for example, transportation of materials or tools that reduces the travel distance of personnel can be provided. Using an aircraft, a screwdriver can be transported from the ground to the fifth floor of a building in less than a minute. A worker would be travelling for several minutes for this purpose.

Using the present invention, it is possible to produce complex structures of building works much more rapidly and efficiently. The cost reduction that can thus be achieved is approximately 30% by comparison with a conventional construction method.

Because of the flexibility of use, the high production speed and the cost efficiency thereof, the system according to the invention can make a significant contribution to more rapid creation of favorable living space. The additive manufacturing method enables particularly economical handling of the material, and thus of our natural resources. The system according to the invention can even be used in narrow building gaps, in which considerable detriments to the nearby environment of a building site otherwise arise if conventional scaffolds or cranes are used. As well as erecting buildings, other advantageous applications are conceivable for a system according to the invention, for example in erecting dams or bridges or in applying road surfaces.

Hereinafter, embodiments of the system according to the invention are described in greater detail with reference to the drawings, in which:

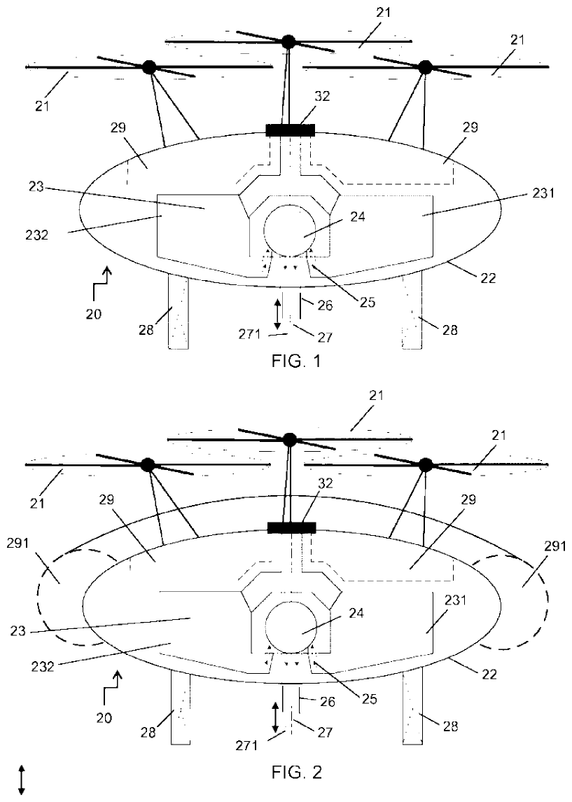

FIG. 1 is a schematic view of an aircraft comprising an integrated material container and a nozzle for applying the material,

FIG. 2 is a schematic view of an aircraft comprising an integrated material container and a nozzle for applying the material, comprising an additional external lifting body,

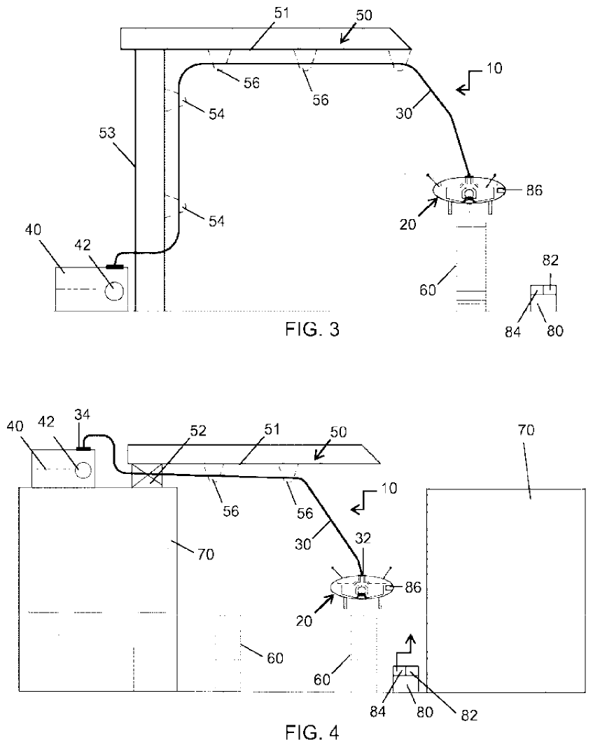

FIG. 3 is a schematic drawing of a system according to the invention comprising a material supply line, which connects an aircraft to a ground-level storage container, and

FIG. 4 is a schematic drawing of a system according to the invention comprising a material supply line, which connects an aircraft to a storage container arranged in an elevated position.

FIGS. 3 and 4 show two different embodiments of a system 10 according to the invention. The system 10 according to the invention comprises a first device 20, which is formed by an aircraft 20 provided with at least one rotor 21.

Two different embodiments of an aircraft 20 of this type, preferably formed by a drone comprising a plurality of rotors 21, are shown schematically by way of example in FIGS. 1 and 2.

As is shown in FIGS. 1 and 2, the system 10 according to the invention further comprises at least one second device 27 for applying material. The at least one second device 27 is formed in the manner of a nozzle or in the manner of a print head, and is connected to a pump 24 via a conveying line 26. The conveying line 26 is preferably formed by or mounted on a handling assistant, which—as indicated by the double-headed arrow in FIGS. 1 and 2—is telescopically extendable or displaceable three-dimensionally, in such a way that the nozzle or print head 27 is displaceable within a particular region even when the aircraft 20 is temporarily floating in a stationary manner. The placement of material in difficult-to-access gaps between reinforcements or armoring is much more easily possible as a result of the displaceability of the nozzle 27, independently of a displacement of the aircraft 20, by way of the displaceable handling assistant 26.

The pump 24 is connected at the input, via at least one supply line 25, to at least one container 23 or a plurality of containers 231 and 232, which serve to store or buffer an in particular liquid or paste material.

The material in at least one of the containers 231, 232 may also be formed powdered or solid and be mixed with a liquid, which is supplied directly from the other container 232, 231 in the second device 27 or via the supply line 25, to form a paste compound. In another variant, a plastics material stored in one of the containers 231, 232 may also for example be melted in or upstream from the device 27 by heating, before application. If a plurality of containers 231, 232 are provided, they may accommodate either the same material or else differing components for producing a material mix that is formed in the second device 27—for example a concrete as the first component and a curing agent for more rapid curing of the concrete as the second component.

The containers 23; 231, 232 are preferably arranged within a housing 22 of the aircraft 20. Alternatively or in addition, however, it is also possible to arrange external containers (not shown) on the housing 22.

As is shown in FIGS. 1 and 2, the aircraft 20 is additionally provided with at least one device 28 for applying attachment parts. These attachment parts may for example be formed by slabs and/or smoothing tools, which delimit the introduced material on both sides of the deice 27 during application and/or smooth it during or after the application. As a further benefit, the device 28 can for example be used, by way of a gripper or mounting provided therein, for transporting material and/or tools on a building site, and can thus support and simplify the logistics. If there are a plurality of aircraft 20 cooperating in a system according to the invention, dedicated special tasks may also be assigned to them. Thus, for example, a first aircraft 20 may “weave” a reinforcing web from a plastics material, a second aircraft 20 may be provided with a nozzle 27 for applying concrete, a third aircraft 20 may be equipped with smoothing tools for smoothing the applied concrete, a fourth aircraft 20 may serve to position window frames in the openings provided therefor, and a fifth aircraft 20 may be provided for applying an insulating outer layer.

To reduce the power required for operating the rotors 21 to produce a floating state of the aircraft 20, lifting containers 29 or 291 are preferably arranged in or on the housing 22. The lifting containers 29 arranged internally in the housing 22 as separate chambers or the lifting containers 291 arranged externally on the housing 22, for example in the form of a peripheral tube, accommodate a gas that has a lower specific weight than air, for example helium or hydrogen.

Either the aircraft 20 are each flown to a loading station to fill the containers 23; 231, 232, or, particularly preferably, as is shown in FIGS. 3 and 4, they are connected to at least one storage container 40 via material supply lines 30. Preferably, a further pump 42, by means of which the material is conveyed from the storage container 40 via the material supply line 30 to the containers 23; 231, 232 or directly to the second device 27, is arranged in or on these storage containers 40.

In this context, the material supply line 30 may comprise a plurality of separate lines that are combined into a line bundle and through which different materials are supplied. The material supply line 30 may also be used for transmitting electrical energy and/or fuels for driving the aircraft 20 or for signal transmission.

The material supply line 30 is connected to the storage container 40 via a connector 34 and to the aircraft 20 via a connector 32.

So as to relieve the aircraft 20 of the weight of the material supply line 30 and the material located therein, support devices 50 are preferably provided, which have at least one substantially horizontal boom 51 and at least one vertical support column 53 or at least one support bearing 52. The material supply line 30 is mounted on these support columns 53 and booms 51 by means of mountings 54 and 56.

In the embodiment of FIG. 3, the storage container 40 is arranged at ground level, in such a way that the material has to be conveyed to the aircraft 20 floating in the air from below via the material supply line 30.

In the alternative embodiment of FIG. 4, the storage container 40 is arranged on a building 70 already present in the neighborhood. In this case, the required power of the pump 42 for conveying the material to the aircraft 20 via the material supply line 30 is much lower.

The system according to the invention preferably serves to erect at least one wall 60 of a building 70.

The system according to the invention is preferably controlled using a control apparatus 80 shown in FIG. 4, which has at least one program memory 82 and at least one transmitter 84. The transmitter 84 is in a preferably wireless data transmission connection with a receiver 86 arranged on the aircraft 20.

The program memory 82 contains a building plan for the building 70, in which all positions and dimensions, including the required clearances for doors and windows, are stored as CAD data for the individual walls 60. The program memory 82 also contains the required amount data of the material that are to be outputted by the second devices 27 at the positions respectively flown to by the aircraft 20 and that are controlled by corresponding actuation of the pumps 24 and 42 or of valves (not shown). Using a processor, the control apparatus 80 converts these CAD data into position coordinates, such as GPS data and/or laser mapping data, which are transmitted to the receiver 86 using the transmitter 84 and by means of which the at least one aircraft 20 approaches the corresponding positions in succession to apply the material.

Conversely, GPS signals or laser mapping data of the aircraft 20 may also be transmitted from a transmitter on the aircraft 20 to a receiver (not shown) on the control apparatus 80, and data for a building plan of a building work to be erected may be determined therefrom.

The system according to the invention comprising the at least one aircraft 20 may also be used in the same manner for calibrating finished building works 70, making it possible to determine the exact current state of a building work. This is used both for quality control during inspection and for periodic monitoring of changes in a building, for example sinking caused by the foundations yielding as a result of land subsidences, earthquakes or earth tremors. This is very useful in particular in regions that are particularly threatened by earthquakes, for an early warning and for exact temporal documentation of different damage states.

### LIST OF REFERENCE NUMERALS

10 System
20 Aircraft (first device, for example drone)
21 Rotor
22 Housing
23 Container (for material)
231 Container (for material component 1)
232 Container (for material component 2)
24 Pump
25 Supply line
26 Conveying line or handling assistant
27 (Second) device (for applying material)
271 Nozzle or print head
28 Device (for mounting attachment parts)
29 Lifting container (internal to 22)
291 Lifting container (external to 20)
30 Material supply line
32 Connector (from 30 to 23)
34 Connector (from 30 to 40)
40 Storage container
42 Pump
50 Supply device
51 Boom
52 Support bearing
53 Support column
54 Mounting
56 Mounting
60 Building part (wall)
70 Building
80 Control apparatus
82 Program memory
84 Transmitter
86 Receiver

1. A system comprising at least one first device movable in a controlled manner and at least one second device, which is arranged on said at least one first device, for applying material, characterized in that the at least one first device movable in a controlled manner is formed by an aircraft provided with at least one rotor, which aircraft comprises at least one container for storing the material.

2. The system according to claim 1, characterized in that the second device comprises at least a nozzle or a print head.

3. The system according to claim 1, characterized in that the at least one container is connected to the second device by means of at least one pump.

4. The system according to claim 1, characterized in that the aircraft has at least two containers.

5. The system according to claim 4, characterized in that the two containers are suitable for receiving different components of the material, which are mixable by way of the second device.

6. The system according to claim 1, characterized in that the second device and/or the at least one container are connected to at least one storage container via at least one material supply line.

7. The system according to claim 6, characterized in that the at least one material supply line is held at a level above the altitude of the aircraft by means of at least one support device.

8. The system according to claim 6, characterized in that the storage container is arranged at a level above the altitude of the aircraft.

9. The system according to claim 1, characterized in that the aircraft is provided with at least one lifting container.

10. The system according to claim 1, characterized in that the aircraft is provided with a receiver, which is in radio connection with a transmitter connected to a control apparatus.

11. The system according to claim 10, characterized in that the control apparatus has at least one program memory for storing at least one operating program comprising position data for the at least one aircraft and comprising material metering data for the device and/or the pump.

12. The system according to claim 1, characterized in that the aircraft is formed by a drone.

13. The system according to claim 1, characterized in that the aircraft is useable for erecting a wall of a building and/or for applying concrete.

14. The system according to claim 1, characterized in that the aircraft is provided with at least one device for applying attachment parts or for transporting materials or tools.

15. The system according to claim 1, characterized in that a conveying line, in particular formed by or mounted on a telescopically extendable or three-dimensionally movable handling assistant, is provided between the at least one container and the second device for applying material.

16. The system according to claim 2, characterized in that the at least one container is connected to the second device by means of at least one pump.

17. The system according to claim 2, characterized in that the aircraft has at least two containers.

18. The system according to claim 2, characterized in that the second device and/or the at least one container are connected to at least one storage container via at least one material supply line.

19. The system according to claim 2, characterized in that the at least one material supply line is held at a level above the altitude of the aircraft by means of at least one support device.

20. The system according to claim 7, characterized in that the storage container is arranged at a level above the altitude of the aircraft.
